(19) United States
(12) Patent Application Publication
(10) Pub. No.: US 2026/0140136 A1
(43) Pub. Date: May 21, 2026

(54) PHYSICAL QUANTITY SENSOR ELEMENT AND PHYSICAL QUANTITY SENSOR DEVICE

(71) Applicant: SEIKO EPSON CORPORATION, Tokyo (JP)

(72) Inventor: Masataka Kazuno, Kofu-shi (JP)

(21) Appl. No.: 19/394,333

(22) Filed: Nov. 19, 2025

(30) Foreign Application Priority Data
Nov. 21, 2024 (JP) 2024-203001

(51) Int. Cl. G01P 15/125; G01P 15/18

(52) U.S. Cl. CPC G01P 15/125; G01P 15/18

(57) ABSTRACT

A physical quantity sensor element includes a beam fixer, a first electrode fixer, and a second electrode fixer, a support beam having one end coupled to the beam fixer and extending in a direction parallel to a support substrate, a movable body coupled to another end of the support beam and disposed on both sides with the support beam interposed therebetween in a plan view, a first movable comb electrode coupled to the movable body and disposed on one side with the support beam interposed therebetween in plan view, a first fixed comb electrode coupled to the first electrode fixer and facing the first movable comb electrode, a second movable comb electrode coupled to the movable body and disposed on another side with the support beam interposed therebetween in plan view, a second fixed comb electrode coupled to the second electrode fixer and facing the second movable comb electrode, and self-diagnosis electrodes interposing the first movable comb electrode, the first fixed comb electrode, the second movable comb electrode, and the second fixed comb electrode.

The present application is based on, and claims priority from JP Application Serial Number 2024-203001, filed Nov. 21, 2024, the disclosure of which is hereby incorporated by reference herein in its entirety.

### BACKGROUND

### 1. Technical Field

The present disclosure relates to a physical quantity sensor element and a physical quantity sensor device.

### 2. Related Art

In the related art, a capacitive physical quantity sensor that detects a change in capacitance formed by a fixed electrode and a movable electrode due to a physical quantity is known. For example, JP-A-2003-121457 discloses a capacitive physical quantity sensor in which fixed electrodes and movable electrodes face each other in parallel and distances between the fixed electrodes and the movable electrodes change in accordance with a physical quantity. JP-A-2003-121457 discloses a configuration in which a voltage is applied between fixed electrodes and movable electrodes, and the movable electrodes are vibrated by changing a voltage value, thereby performing self-diagnosis.

In the related art described above, the fixed electrode and the movable electrode constitute a parallel plate electrode, and a distance between the fixed electrode and the movable electrode changes in a direction perpendicular to the plate in accordance with the physical quantity. However, as the capacitive physical quantity sensor, there is a sensor of a type in which the movable electrode is displaced in a direction parallel to the plate. In such a type of sensor, even when a voltage is applied between the fixed electrode and the movable electrode, it is difficult to displace and vibrate the movable electrode in a direction parallel to the plate by a change in voltage value. Therefore, it is difficult to perform self-diagnosis in a sensor of a type in which the movable electrode is displaced in the direction parallel to the plate.

### SUMMARY

A physical quantity sensor element according to an embodiment includes a beam fixer, a first electrode fixer, and a second electrode fixer, which extend in a direction perpendicular to a support substrate, a support beam having one end coupled to the beam fixer and extending in a direction parallel to the support substrate, a movable body coupled to another end of the support beam and is present on both sides with the support beam interposed therebetween in a plan view, a first movable comb electrode coupled to the movable body and is present on one side with the support beam interposed therebetween in plan view, a first fixed comb electrode coupled to the first electrode fixer and facing the first movable comb electrode, a second movable comb electrode coupled to the movable body and is present on another side with the support beam interposed therebetween in plan view, a second fixed comb electrode coupled to the second electrode fixer and facing the second movable comb electrode, and self-diagnosis electrodes interposing the first movable comb electrode, the first fixed comb electrode, the second movable comb electrode, and the second fixed comb electrode.

### BRIEF DESCRIPTION OF THE DRAWINGS

FIG. 1 is a plan view of a physical quantity sensor device according to the present embodiment.

FIG. 2 is a plan view of a Z-direction acceleration sensor element according to the present embodiment.

FIG. 3 is a sectional view of the Z-direction acceleration sensor element.

FIG. 4 is a diagram for explaining operation of a detector of the Z-direction acceleration sensor element.

FIG. 5 is an explanatory diagram of a circuit for detecting acceleration.

FIG. 6 is a diagram showing a signal waveform at the time of switching from normal acceleration detection to self-diagnosis.

FIG. 7 is an enlarged view of a signal waveform at the time of acceleration detection.

FIG. 8 is a graph showing a resonance frequency characteristic of a movable electrode.

FIG. 9 is an explanatory diagram of a circuit for detecting acceleration.

FIG. 10 is a diagram showing a signal waveform at the time of switching from normal acceleration detection to self-diagnosis.

FIG. 11 is a diagram showing a relationship between voltage and displacement.

### DESCRIPTION OF EMBODIMENTS

The present embodiment will be described below. It should be noted that the present embodiment described below does not unduly limit the content of the description of the claims. In addition, not all of the configurations described in the present embodiment are necessarily essential configuration requirements.

### 1. Configuration of Physical Quantity Sensor Device:

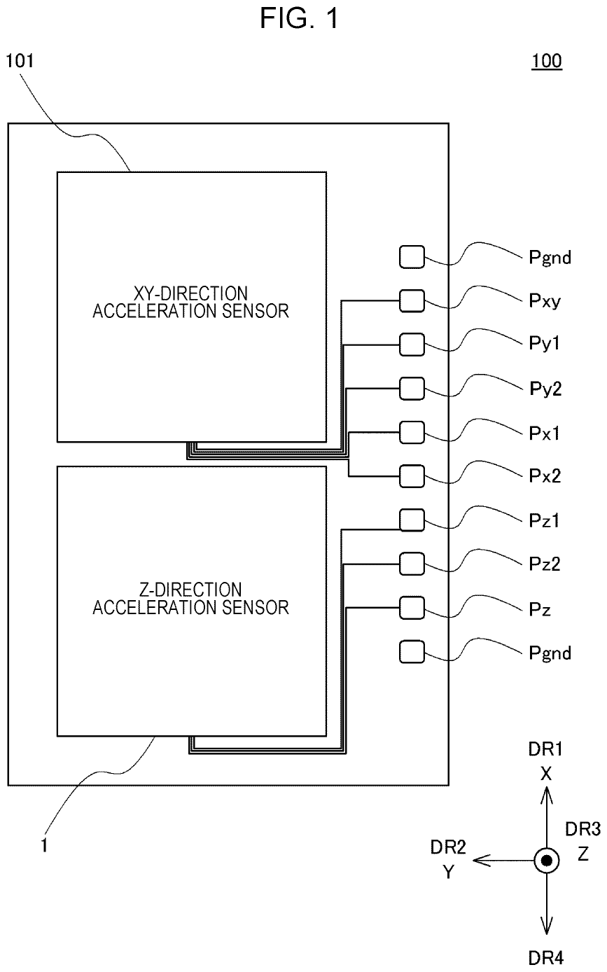

A physical quantity sensor device 100 of the present embodiment is accommodated in a substantially rectangular parallelepiped package. FIG. 1 is a plan view showing a state in which the physical quantity sensor device 100 is viewed in a direction perpendicular to a largest surface of the rectangular parallelepiped. A state in which respective components are viewed in the direction is referred to as a plan view. The physical quantity sensor device 100 according to the present embodiment includes a plurality of physical quantity sensor elements. Specifically, the physical quantity sensor device 100 includes a Z-direction acceleration sensor element 1 and an XY-direction acceleration sensor element 101. Each sensor element is a Micro Electro Mechanical Systems (MEMS) device.

In the present specification, for convenience of description, dimensions of each member, intervals between the members, and the like are schematically shown, and not all the constituent elements are shown. For example, electrode wiring, electrode terminals, and the like are not shown in some cases. In addition, in the present embodiment, a case where a physical quantity detected by the Z-direction acceleration sensor element 1 and the XY-direction acceleration sensor element 101 is acceleration will be mainly described as an example, but the physical quantity is not limited to acceleration, and may be another physical quantity such as velocity, pressure, displacement, posture, angular velocity, or gravity. In addition, each physical quantity sensor element may be used as a pressure sensor, a MEMS switch, or the like.

Further, in the present specification, directions orthogonal to each other are referred to as a first direction DR1, a second direction DR2, and a third direction DR3. The first direction DR1, the second direction DR2, and the third direction DR3 are, for example, an X-axis direction, a Y-axis direction, and a Z-axis direction, respectively, but are not limited thereto. For example, the third direction DR3 corresponding to the Z-axis direction is a direction perpendicular to the largest surface of the rectangular parallelepiped formed by the physical quantity sensor device 100, and is a vertical direction. A direction opposite to the third direction DR3 is referred to as a fifth direction DR5. In addition, the first direction DR1 corresponding to the X-axis direction and the second direction DR2 corresponding to the Y-axis direction are directions orthogonal to the third direction DR3, and an XY plane which is a plane along the first direction DR1 and the second direction DR2 is along, for example, a horizontal plane. A direction opposite to the first direction DR1 is referred to as a fourth direction DR4, and the fourth direction DR4 is, for example, a −X-axis direction. When it is not particularly necessary to distinguish an opposite direction, the fourth direction DR4 may be regarded as a direction along the first direction DR1. The term “orthogonal” includes not only a case of intersecting at 90°, but also a case of intersecting at an angle slightly inclined from 90°.

In FIG. 1, a plurality of pads included in the physical quantity sensor device 100 are also shown. A pad Pgnd is a pad electrically coupled to a ground. A pad Pxy is a pad electrically coupled to a movable comb electrode (not shown) included in the XY-direction acceleration sensor element 101, and has a common potential in the XY-directions. A pad Py1 is a pad electrically coupled to a fixed comb electrode (not shown) included in the XY-direction acceleration sensor element 101, and has a potential for detecting acceleration in the Y direction. A pad Py2 is a pad electrically coupled to the fixed comb electrode (not shown) included in the XY-direction acceleration sensor element 101, and has a potential opposite in phase to that of the pad Py1 in order to detect acceleration in the Y direction.

A pad Px1 is a pad electrically coupled to a fixed comb electrode (not shown) included in the XY-direction acceleration sensor element 101, and has a potential for detecting acceleration in the X direction. A pad Px2 is a pad electrically coupled to the fixed comb electrode (not shown) included in the XY-direction acceleration sensor element 101, and has a potential opposite in phase to that of the pad Px1 in order to detect acceleration in the X direction.

A pad Pz is electrically coupled to a first movable comb electrode and a second movable comb electrode, which will be described later, included in the Z-direction acceleration sensor element 1. A pad Pz1 is a pad electrically coupled to a first fixed comb electrode, which will be described later, included in the Z-direction acceleration sensor element 1, and has a potential for detecting acceleration in the Z-direction. A pad Pz2 is a pad electrically coupled to a second fixed comb electrode, which will be described later, included in the Z-direction acceleration sensor element 1, and has a potential opposite in phase to that of the pad Pz1 in order to detect acceleration in the Z-direction.

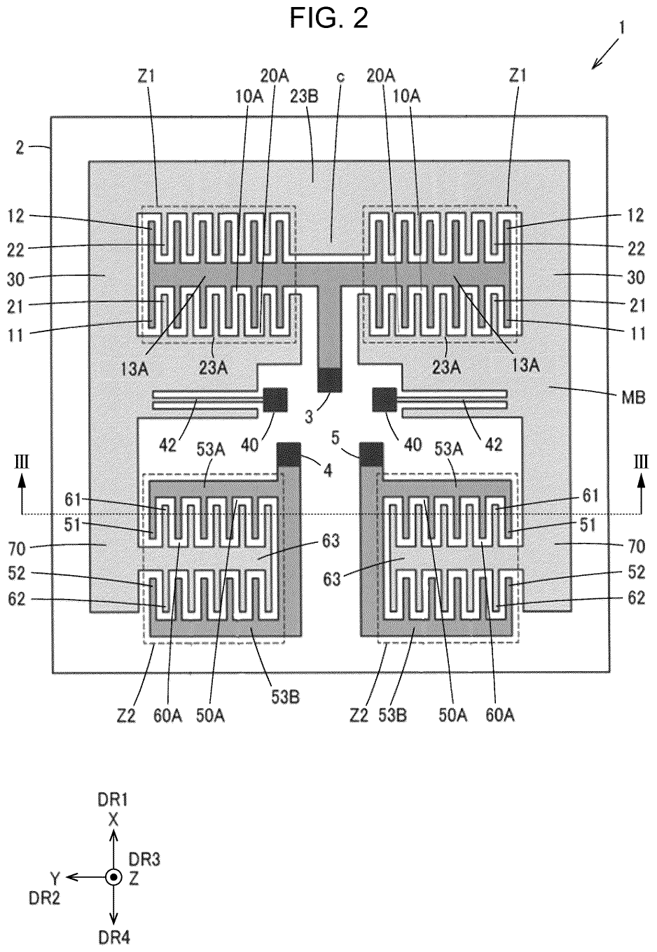

FIG. 2 is a plan view of the Z-direction acceleration sensor element 1. A support substrate 2 is, for example, a silicon substrate made of semiconductor silicon, or a glass substrate made of a glass material such as borosilicate glass, and the like. However, the constituent material of the support substrate 2 is not particularly limited, and a quartz substrate, a silicon on insulator (SOI) substrate, or the like may be used.

As shown in FIG. 2, the Z-direction acceleration sensor element 1 of the present embodiment includes a beam fixer 40, a support beam 42, a movable body MB, a first fixed electrode 10A, and a second fixed electrode 50A. The movable body MB includes a first coupler 30, a first base 23A, a first movable electrode 20A, a second coupler 70, a second base 63, and a second movable electrode 60A. The first fixed electrode 10A includes a plurality of first fixed comb electrodes 11 and 12, and the second fixed electrode 50A includes a plurality of second fixed comb electrodes 51 and 52. The first movable electrode 20A includes a plurality of first movable comb electrodes 21 and 22, and the second movable electrode 60A includes a plurality of second movable comb electrodes 61 and 62.

Then, as indicated by a broken-line frame in FIG. 2, the Z-direction acceleration sensor element 1 has a detector Z1 and a detector Z2, and each detector detects a physical quantity such as an acceleration in a direction along the third direction DR3, which is the Z-axis direction. The detectors Z1 and Z2 are respectively provided on the first direction DR1 side and the fourth direction DR4 side of the support beam 42 in plan view. The detector Z1 provided on the first direction DR1 side of the support beam 42 includes the first fixed electrode 10A and the first movable electrode 20A. The detector Z2 provided on the fourth direction DR4 side of the support beam 42 includes the second fixed electrode 50A and the second movable electrode 60A.

In the above-described configuration, the beam fixer 40 is a substantially rectangular parallelepiped portion extending from a surface parallel to the first direction DR1 and the second direction DR2 of the support substrate 2 toward the third direction DR3. The beam fixer 40 is located at the center of rotation when the movable body MB swings, and serves as an anchor in the swinging motion. One end of the support beam 42 is coupled to the beam fixer 40. The support beam 42 extends in the second direction DR2. Therefore, the support beam 42 extends parallel to a plane parallel to the first direction DR1 and the second direction DR2 of the support substrate 2. This state is expressed as the support beam 42 extending in a direction parallel to the support substrate 2.

The other end of the support beam 42 is coupled to the first coupler 30 and the second coupler 70 of the movable body MB. The first coupler 30 is present on the first direction DR1 side when viewed from the support beam 42, and the second coupler 70 is present on the fourth direction DR4 side when viewed from the support beam 42. Therefore, the movable body MB is coupled to the other end of the support beam 42 and present on both sides with the support beam 42 interposed therebetween in plan view. The first couplers 30 present on the second direction DR2 side of the support substrate 2 and the opposite direction side of the second direction DR2 are coupled by a third coupler 23B extending along the second direction DR2.

The support beam 42 functions as a torsion spring and applies a restoring force in the swinging motion of the movable body MB. As shown in FIG. 2, the support beam 42 is provided such that the second direction DR2 becomes a longitudinal direction in plan view. As shown in FIG. 2, the support beam 42 has a thickness in the first direction DR1 that is smaller than that of the beam fixer 40, and is configured to bend with respect to the swinging motion of the movable body MB. By twisting about the Y-axis, which is the second direction DR2, a restoring force is provided in the swinging motion of the movable body MB. As described above, in the present embodiment, the support beam 42 is a torsion spring that twists with the second direction DR2 as a rotation axis. In this way, the movable body MB can perform a swinging motion with the second direction DR2 as a rotation axis.

When the movable body MB performs the swing motion, the first movable electrode 20A and the second movable electrode 60A of the movable body MB also move in conjunction with the swinging motion. In the present embodiment, the physical quantity is detected by detecting a change, in accordance with the swing, in a capacitance formed by the first movable comb electrodes 21 and 22 and the first fixed comb electrodes 11 and 12 facing each other, and in a capacitance formed by the second movable comb electrodes 61 and 62 and the second fixed comb electrodes 51 and 52 facing each other.

The first coupler 30 couples the other end of the support beam 42, which is not coupled to the beam fixer 40, to the first base 23A. The second coupler 70 couples the other end of the support beam 42 to the second base 63. The first coupler 30 extends on the first direction DR1 side of the support beam 42, and is coupled to the first base 23A on the first direction DR1 side of the support beam 42. The second coupler 70 extends on the fourth direction DR4 side of the support beam 42, and is coupled to the second base 63 on the fourth direction DR4 side of the support beam 42. In this way, the first coupler 30 couples the first base 23A to the support beam 42, and the second coupler 70 couples the second base 63 to the support beam 42, such that each is at a constant distance from the support beam 42, which serves as the rotation axis of the movable body MB.

The first base 23A forms a base of the first movable comb electrodes 21 and 22 of the first movable electrode 20A. That is, as shown in FIG. 2, in plan view, the plurality of first movable comb electrodes 21 and 22 extend from the first base 23A as a base on the first direction DR1 side of the first base 23A. In this way, the first movable comb electrodes 21 and 22 are coupled to the movable body MB, and is present on the first direction DR1 side which is one side of the support beam 42 in plan view. The first base 23A is coupled to the support beam 42 by the first coupler 30 so as to be located at a constant distance from the rotation axis of the movable body MB.

The second base 63 forms a base of the second movable comb electrodes 61 and 62 of the second movable electrode 60A. In the detector Z2, the second base 63 has the same function as the first base 23A in the detector Z1. That is, in plan view, the plurality of second movable comb electrodes 61 and 62 extend from the second base 63 toward the first direction DR1 side and the fourth direction DR4 side. In this way, the second fixed comb electrodes 51 and 52 are coupled to the movable body MB, and is present on the fourth direction DR4 side which is the other side of the support beam 42 in plan view. The second base 63 is coupled to the support beam 42 by the second coupler 70 so as to be located at a constant distance from the rotation axis of the movable body MB.

With such a configuration, the first base 23A, together with the first coupler 30, couples the first movable comb electrodes 21 and 22 of the first movable electrode 20A so as to be at a constant distance from the rotation axis in the swinging motion of the movable body MB. Then, the second base 63, together with the second coupler 70, couples the second movable comb electrodes 61 and 62 of the second movable electrode 60A so as to be at a constant distance from the rotation axis of the swinging motion. That is, when the first movable electrode 20A and the second movable electrode 60A are regarded as an integrated structure including the movable comb electrode, the first movable electrode 20A and the second movable electrode 60A are disposed at symmetrical positions with respect to the Y-axis including the support beam 42 in plan view. The first movable comb electrodes 21 and 22 of the first movable electrode 20A extend in the first direction DR1 and the fourth direction DR4, and the second movable comb electrodes 61 and 62 of the second movable electrode 60A also extend in the first direction DR1 and the fourth direction DR4.

The first fixed comb electrodes 11 and 12 of the first fixed electrode 10A and the first movable comb electrodes 21 and 22 of the first movable electrode 20A are probe electrodes in the detector Z1. The first fixed comb electrodes 11 and 12 of the first fixed electrode 10A are probe electrodes fixed to the support substrate 2, and the first movable comb electrodes 21 and 22 of the first movable electrode 20A are probe electrodes capable of moving integrally with the movable body MB. The physical quantity can be detected by the change in the capacitance formed by the first fixed comb electrodes 11 and 12 of the first fixed electrode 10A and the first movable comb electrodes 21 and 22 of the first movable electrode 20A.

A first electrode fixer 3 is a portion that supports the first fixed electrode 10A. The first electrode fixer 3 is a substantially rectangular parallelepiped portion extending from a surface of the support substrate 2 parallel to the first direction DR1 and the second direction DR2 toward the third direction DR3. The first electrode fixer 3 fixes the first fixed electrode 10A to the support substrate 2. That is, the first fixed electrode 10A includes a first fixed electrode base 13A extending in the second direction DR2, and the first fixed electrode base 13A is coupled to a portion extending from the first electrode fixer 3 in the first direction DR1.

As described above, the first fixed electrode 10A is fixed to the support substrate 2 via the first electrode fixer 3. As shown in FIG. 2, the first fixed electrode 10A is provided on the first direction DR1 side of the support beam 42. Further, comb-shaped first fixed comb electrodes 11 and 12 extending from the first fixed electrode base 13A to the first direction DR1 side and the fourth direction DR4 side are provided on the first fixed electrode 10A. That is, the first fixed comb electrodes 11 and 12 are coupled to the first electrode fixer 3, extends in a direction parallel to the support substrate 2, and faces the first movable comb electrodes 21 and 22.

Second electrode fixers 4 and 5 are portions that support the second fixed electrode 50A. The second electrode fixers 4 and 5 are substantially rectangular parallelepiped portions extending from a surface of the support substrate 2 parallel to the first direction DR1 and the second direction DR2 toward the third direction DR3. Each of the second electrode fixers 4 and 5 fixes the second fixed electrode 50A to the support substrate 2. That is, the second fixed electrode 50A includes second fixed electrode bases 53A and 53B extending in the second direction DR2, and the second fixed electrode bases 53A and 53B are coupled to portions extending in the fourth direction DR4 from the second electrode fixers 4 and 5.

As described above, the second fixed electrode 50A is fixed to the support substrate 2 via the second electrode fixers 4 and 5. As shown in FIG. 2, the second fixed electrode 50A is provided on the fourth direction DR4 side of the support beam 42. The second fixed electrode 50A is provided with a comb-shaped second fixed comb electrode 51 extending from the second fixed electrode base 53A toward the fourth direction DR4 side, and a comb-shaped second fixed comb electrode 52 extending from the second fixed electrode base 53B toward the first direction DR1 side. That is, the second fixed comb electrodes 51 and 52 are coupled to the second electrode fixers 4 and 5, extend in a direction parallel to the support substrate 2, and face the second movable comb electrodes 61 and 62.

The first electrode fixer 3 and the second electrode fixers 4 and 5 are rectangular parallelepiped portions extending from the support substrate 2, and the portions colored in black in FIG. 2 are portions extending from the support substrate 2, but the first electrode fixer 3 and the second electrode fixers 4 and 5 may be coupled to the support substrate 2 via a portion having a larger area.

The first electrode fixer 3 is provided at a position closer to the beam fixer 40 than the first fixed electrode 10A in the first direction DR1 of the support beam 42, and the second electrode fixers 4 and 5 are provided at positions closer to the beam fixer 40 than the second fixed electrode 50A in the fourth direction DR4 of the support beam 42. Therefore, even when warpage occurs in the support substrate 2, the influence thereof is less likely to be received, output variation caused by external stress, heat, or the like of the Z-direction acceleration sensor element 1 can be suppressed, and the detection of the physical quantity with high accuracy becomes possible.

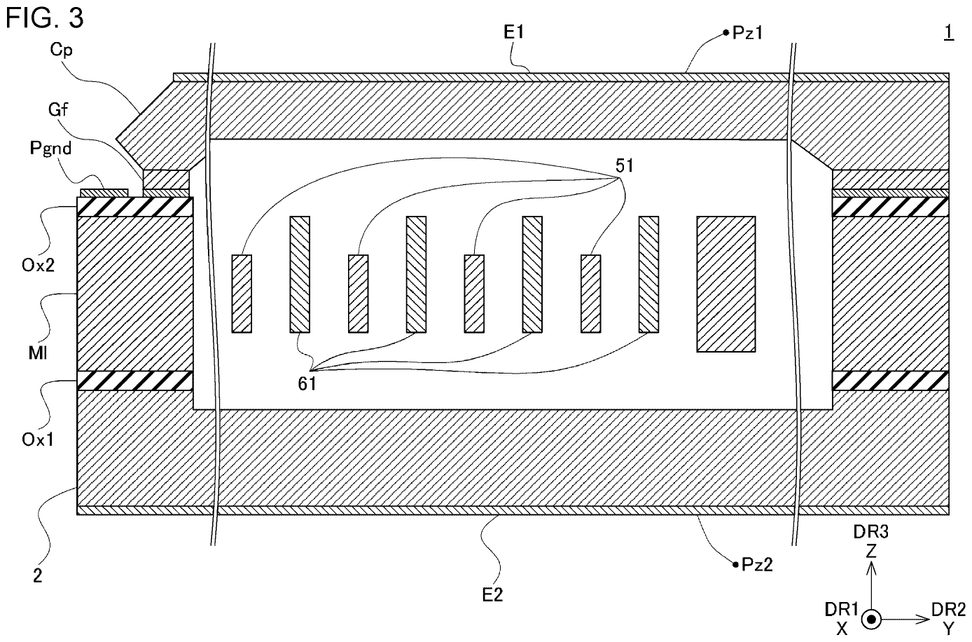

FIG. 3 is a diagram showing a simplified sectional view of the Z-direction acceleration sensor element 1. A cutting plane location of the sectional view shown in FIG. 3 is a position of line III-III in FIG. 2, and FIG. 3 mainly shows a structure of the second fixed comb electrode 51 belonging to the second fixed electrode 50A, which is present at the lower right in FIG. 2, and the second movable comb electrode 61. The cross-sectional shapes of the second fixed comb electrode 51 and the second movable comb electrode 61 are rectangular parallelepipeds, and extend in the fourth direction DR4 and the first direction DR1 with the same cross-sectional shapes. Therefore, the second fixed comb electrode 51 is a rectangular parallelepiped portion extending along the fourth direction DR4 from the second fixed electrode base 53A, and the second movable comb electrode 61 is a rectangular parallelepiped portion extending along the fourth direction DR4 from the second base 63.

The support substrate 2 is a substantially rectangular parallelepiped member, but a recess is formed in one surface on a space side in which the second fixed comb electrode 51 and the like are accommodated. The Z-direction acceleration sensor element 1 can be regarded as being composed of a plurality of layers, which are a first oxide layer Ox1, a sensor structure formation layer Ml, and a second oxide layer Ox2 in order from the support substrate 2 in the third direction DR3. A layer next to the second oxide layer Ox2 is a wiring layer, and the pad Pgnd, other pads, and various wirings are formed by conductors. The wiring layer is followed by a glass frit layer Gf, and a lid Cp is formed as the next layer. The lid Cp is disposed at a position facing the support substrate 2. That is, although the support substrate 2 and the lid Cp have various structures such as a recess formed therein, their general shapes are rectangular parallelepipeds, and they are disposed such that their largest surfaces are parallel to each other.

The sensor structure formation layer Ml is a layer that forms a structure such as the second fixed comb electrode 51. In the sensor structure formation layer Ml, an outer periphery in plan view forms a rectangular frame, and a space that is surrounded by the frame and is interposed between the support substrate 2 and the lid Cp serves as an accommodation space for structures such as the second fixed comb electrode 51 and the like. The glass frit layer Gf is in contact with the lid Cp to seal the accommodation space. In the present embodiment, the sensor structure formation layer Ml and the lid Cp are formed of silicon. However, the material of each layer is not limited, and each layer may be made of a glass material such as borosilicate glass, or may be made of a silicon on insulator (SOI) or the like.

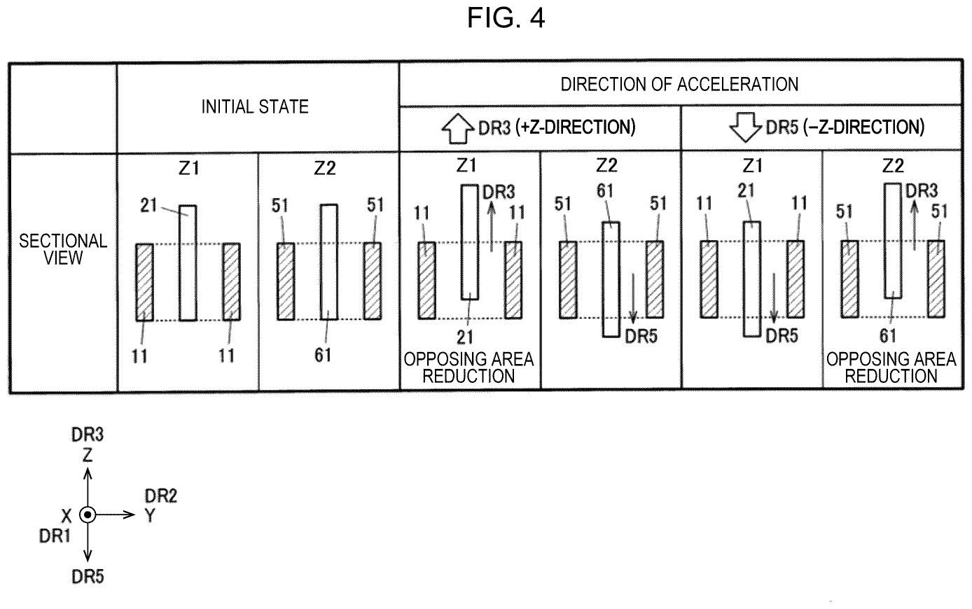

FIG. 4 is a diagram for explaining operation of the detectors Z1 and Z2 of the Z-direction acceleration sensor element 1 according to the present embodiment. Specifically, when acceleration occurs from an initial state, the movement of the first movable comb electrode 21 and the second movable comb electrode 61 with respect to the direction of the acceleration is shown by a schematic sectional view when each of the electrodes is viewed along the first direction DR1. Here, the initial state refers to a stationary state in which no acceleration occurs except for gravitational acceleration.

In the initial state shown in the left column of FIG. 4, the first fixed comb electrodes 11 and the first movable comb electrode 21 of the detector Z1 are provided to face each other such that a part of the electrodes 11 overlaps with the electrode 21 along the third direction DR3. Specifically, positions of end portions of the first fixed comb electrodes 11 and the first movable comb electrode 21 in the fifth direction DR5 coincide with each other, but positions of end portions in the third direction DR3 are such that the end portion of the first movable comb electrode 21 is located closer to the third direction DR3 side than the end portions of the first fixed comb electrodes 11. In the initial state, the first fixed comb electrodes 11 and the first movable comb electrode 21 are stationary in a state of partially overlapping each other along the third direction DR3 in this way. In addition, the second fixed comb electrodes 51 and the second movable comb electrode 61 of the detector Z2 are also provided to face each other along the third direction DR3 so as to partially overlap each other, and the end portion of the second movable comb electrode 61 is located closer to the third direction DR3 side than the end portions of the second fixed comb electrodes 51 in the third direction DR3.

In this initial state, the electrostatic capacitance in the initial state is obtained by the electrostatic capacitance corresponding to the opposing area of the first fixed comb electrodes 11 and the first movable comb electrode 21 in the detector Z1 and the electrostatic capacitance corresponding to the opposing area of the second fixed comb electrodes 51 and the second movable comb electrode 61 in the detector Z2.

Next, the operation in a state where the acceleration in the third direction DR3 occurs as shown in the middle column of FIG. 4 will be described. In a state where the acceleration in the third direction DR3 occurs, the second movable comb electrode 61 in the detector Z2 receives an inertia force in the opposite direction to the direction of the acceleration. Therefore, the second movable comb electrode 61 of the detector Z2 is displaced toward the fifth direction DR5 side, that is, in a −Z-direction, and the first movable comb electrode 21 of the detector Z1 is displaced in a +Z-direction opposite to the second movable comb electrode 61. Accordingly, the opposing area of the second fixed comb electrodes 51 and the second movable comb electrode 61 are maintained in the detector Z2, and the opposing area of the first fixed comb electrodes 11 and the first movable comb electrode 21 is reduced in the detector Z1. Therefore, the acceleration in the third direction DR3 can be detected by detecting a change in electrostatic capacitance due to a reduction in the opposing area in the detector Z1.

On the other hand, as shown in the right column of FIG. 4, in a state where the acceleration in the fifth direction DR5 occurs from the initial state, the second movable comb electrode 61 receives the inertia force in the third direction DR3. Therefore, in the detector Z2, the second movable comb electrodes 61 are displaced in the third direction DR3, and the first movable comb electrode 21 in the detector Z1 is displaced in the opposite direction, that is, toward the fifth direction DR5. As a result, the opposing area of the second fixed comb electrodes 51 and the second movable comb electrode 61 are reduced in the detector Z2, and the opposing area of the first fixed comb electrodes 11 and the first movable comb electrode 21 is maintained in the detector Z1. Therefore, the acceleration in the fifth direction DR5 can be detected by detecting a change in the electrostatic capacitance due to a reduction in the opposing area of the detector Z2.

In the present embodiment, when acceleration in the third direction DR3 or the fifth direction DR5 occurs, it is the second movable comb electrode 61 of the detector Z2 that is displaced in the opposite direction to the direction of the acceleration. This is because the movable body MB provided on the fourth direction DR4 side, that is, the movable body MB on the detector Z2 side is heavier than the movable body MB provided on the first direction DR1 side, that is, the movable body MB on the detector Z1 side.

In the present embodiment, the thickness in the third direction DR3 of the first movable comb electrodes 21 and 22 of the first movable electrode 20A is greater than the thickness in the third direction DR3 of the first fixed comb electrodes 11 and 12 of the first fixed electrode 10A, and the thickness in the third direction DR3 of the second movable comb electrodes 61 and 62 of the second movable electrode 60A is greater than the thickness in the third direction DR3 of the second fixed comb electrodes 51 and 52 of the second fixed electrode 50A.

In this way, when the acceleration occurs in the third direction DR3, the opposing area of the first fixed comb electrodes 11 and 12 and the first movable comb electrodes 21 and 22 are reduced in the detector Z1, and the opposing area of the second fixed comb electrodes 51 and 52 and the second movable comb electrodes 61 and 62 are maintained in the detector Z2, so that a change in acceleration in the third direction DR3 can be detected. In addition, when the acceleration occurs in the fifth direction DR5, the opposing area of the second fixed comb electrodes 51 and 52 and the second movable comb electrodes 61 and 62 are reduced in the detector Z2, and the opposing area of the first fixed comb electrodes 11 and 12 and the first movable comb electrodes 21 and 22 are maintained in the detector Z1. Therefore, the acceleration in the fifth direction DR5 can be detected.

As described above, in the Z-direction acceleration sensor element 1 according to the present embodiment, the first movable comb electrodes 21 and 22 and the second movable comb electrodes 61 and 62 swing along the third direction DR3. On the other hand, the first movable comb electrodes 21 and 22 and the second movable comb electrodes 61 and 62 have a structure in which a rectangular parallelepiped extends from the movable body MB toward the first direction DR1 side and the fourth direction DR4 side, and hardly move in the second direction DR2.

On the other hand, in the XY-direction acceleration sensor element 101, electrostatic capacitance is formed by the fixed comb electrodes and the movable comb electrodes facing each other. However, in the XY-direction acceleration sensor element 101, the distance between the fixed comb electrodes and the movable comb electrodes is displaced according to the acceleration acting on the XY-direction acceleration sensor element 101 along the first direction DR1 and the second direction DR2, whereby the electrostatic capacitance changes. The XY-direction acceleration sensor element 101 can detect changes in the acceleration along the first direction DR1 and the second direction DR2 based on the changes in the electrostatic capacitance.

### 2. Detection Circuit:

Next, a circuit for detecting changes in the acceleration along the first direction DR1 and the second direction DR2 and changes in the acceleration along the third direction DR3 using the above-described configuration will be described. First, a circuit for detecting changes in the acceleration along the first direction DR1 and the second direction DR2 will be described.

### 2-1. XY-Direction Acceleration Sensor Element

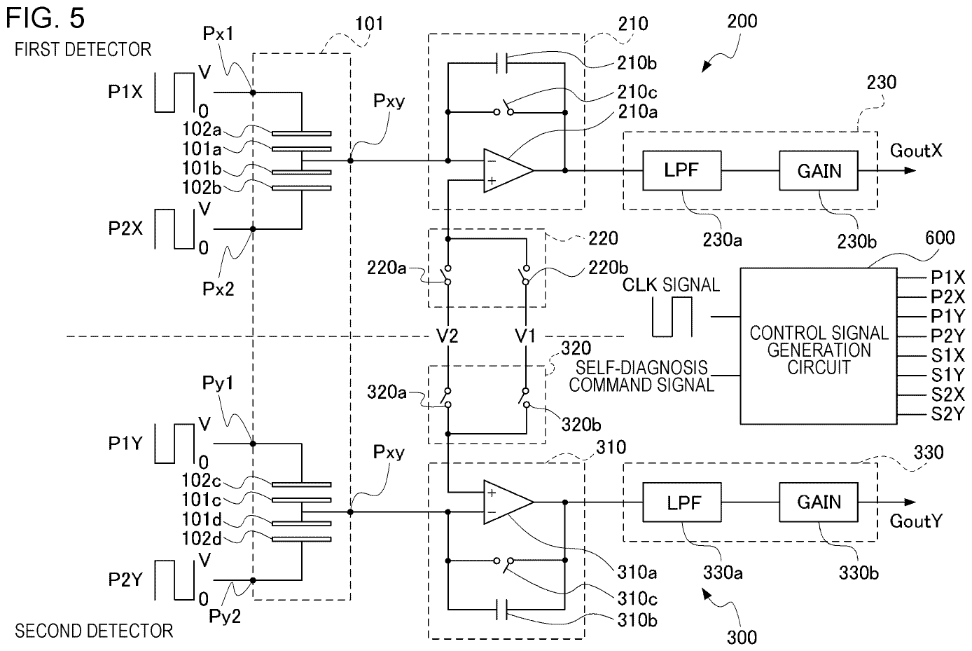

The XY-direction acceleration sensor element 101 is used by being coupled to a control IC (not shown). The control IC includes a circuit for detecting acceleration based on a signal output from the XY-direction acceleration sensor element 101. FIG. 5 is a diagram for explaining the circuit. In FIG. 5, the XY-direction acceleration sensor element 101 is shown together with elements and wirings constituting the circuit.

However, in FIG. 5, details of the structure of the XY-direction acceleration sensor element 101 are omitted, and movable electrodes 101a, 101b, 101c, and 101d and fixed electrodes 102a, 102b, 102c, and 102d included in the XY-direction acceleration sensor element 101 are schematically shown.

The movable electrodes 101a and 101b and the fixed electrodes 102a and 102b constitute a parallel-plate capacitor oriented in a direction perpendicular to the first direction DR1. The movable electrodes 101a and 101b are electrodes displaced in the first direction DR1 in accordance with acceleration in the X-direction which is the first direction DR1. The positions of the fixed electrodes 102a and 102b are not displaced. When the movable electrodes 101a and 101b are displaced in the first direction DR1 in accordance with the acceleration in the X-direction which is the first direction DR1, the electrostatic capacitance formed by the movable electrode 101a and the fixed electrode 102a and the electrostatic capacitance formed by the movable electrode 101b and the fixed electrode 102b change.

The movable electrodes 101c and 101d and the fixed electrodes 102c and 102d constitute a parallel-plate capacitor oriented in a direction perpendicular to the second direction DR2. The movable electrodes 101c and 101d are electrodes displaced in the second direction DR2 in accordance with acceleration in the Y-direction which is the second direction DR2. The positions of the fixed electrodes 102c and 102d are not displaced. When the movable electrodes 101c and 101d are displaced in the second direction DR2 in accordance with the acceleration in the Y-direction which is the second direction DR2, the electrostatic capacitance formed by the movable electrode 101c and the fixed electrode 102c and the electrostatic capacitance formed by the movable electrode 101d and the fixed electrode 102d change.

As shown in FIG. 1, the XY-direction acceleration sensor element 101 includes a plurality of pads, and FIG. 5 shows coupling relationships between the pads Pxy, Px1, Px2, Py1, and Py2 and the circuit components, as well as coupling relationships between the movable electrodes 101a, 101b, 101c, and 101d, and the fixed electrodes 102a, 102b, 102c, and 102d

Here, a configuration for detecting acceleration in the X-direction, which is the first direction DR1, is referred to as a first detector, and a configuration for detecting acceleration in the Y-direction, which is the second direction DR2, is referred to as a second detector. The first detector includes a detection circuit 200 that detects acceleration based on a change in differential capacitance due to the movable electrodes 101a and 101b and the fixed electrodes 102a and 102b. In addition, the second detector includes a detection circuit 300 that detects acceleration based on a change in differential capacitance due to the movable electrodes 101c and 101d and the fixed electrodes 102c and 102d.

In the present embodiment, in the XY-direction acceleration sensor element 101, electrodes for detecting acceleration in the first direction DR1 and electrodes for detecting acceleration in the Y-direction, which is the second direction DR2, are formed in the same chip, but each electrode may be formed on separate chips.

The detection circuits 200 and 300 include C-V conversion circuits 210 and 310, switch circuits 220 and 320, signal processing circuits 230 and 330, and a control signal generation circuit 600.

The C-V conversion circuits 210 and 310 are circuits that convert changes in the differential capacitance of the electrostatic capacitance formed by the movable electrodes 101a to 101d and the fixed electrodes 102a to 102d into voltages. Specifically, the C-V conversion circuits 210 and 310 include operational amplifiers 210a and 310a, capacitors 210b and 310b, and switches 210c and 310c.

The inverting input terminals of the operational amplifiers 210a and 310a are electrically coupled to the movable electrodes 101a and 101b, and 101c and 101d, respectively, and the capacitors 210b and 310b and the switches 210c and 310c are coupled in parallel between the inverting input terminals and the output terminals. The switch 210c is driven by a signal S1X from a control signal generation circuit 600, and the switch 310c is driven by a signal S1Y from the control signal generation circuit 600. To the non-inverting input terminals of the operational amplifiers 210a and 310a, one of a voltage V1 (that is, a midpoint voltage, 2.5 V in the present embodiment) which is half the voltage applied to the fixed electrodes 102a to 102d and a voltage V2 (4 V in the present embodiment) which is different from the midpoint voltage is input via the switch circuits 220 and 320.

The switch circuits 220 and 320 input voltages from respective voltage sources (not shown) to the non-inverting input terminals of the operational amplifiers 210a and 310a in the C-V conversion circuits 210 and 310. Specifically, the switch circuit 220 includes switches 220a and 220b, and the switch circuit 320 includes switches 320a and 320b. Among them, the switches 220a and 220b are driven based on a signal S2X from the control signal generation circuit 600, and the switches 320a and 320b are driven based on a signal S2Y from the control signal generation circuit 600, so that when one of the switches is closed, the other is opened.

The signal processing circuits 230 and 330 include low pass filter (LPF) circuits 230a and 330a and GAIN circuits 230b and 330b. The LPF circuits 230a and 330a serve to remove high-frequency components from the output of the C-V conversion circuits 210 and 310, and to extract only components within a predetermined frequency band. The GAIN circuits 230b and 330b amplify the output after passing through the LPF circuits 230a and 330a, and output the amplified output as acceleration signals GoutX and GoutY.

The control signal generation circuit 600 outputs signals (carrier waves) P1X, P2X, P1Y, and P2Y indicating the voltage application timing to the fixed electrodes 102a to 102d, signals S2X and S2Y indicating the switching timing of the switches of the switch circuits 220 and 320, and signals S1X and S1Y indicating the switching timing of the switches 210c and 310c.

The various signals generated by the control signal generation circuit 600 vary between the time of normal acceleration detection (when not in self-diagnosis) and the time of self-diagnosis. That is, the control signal generation circuit 600 outputs various signals based on a clock signal CLK, and outputs a signal for acceleration detection when a self-diagnosis command signal is at a Low level, and outputs a signal for self-diagnosis when the self-diagnosis command signal is at a Hi level.

The self-diagnosis is processing in which a signal for self-diagnosis is input to the XY-direction acceleration sensor element 101, and it is determined to be normal when the obtained output is within a predetermined value range, and it is determined to be abnormal when the obtained output is out of the range. That is, when the obtained output is out of the predetermined value range, it can be considered that an abnormality such as breakage of the comb teeth included in the XY-direction acceleration sensor element 101 occurs.

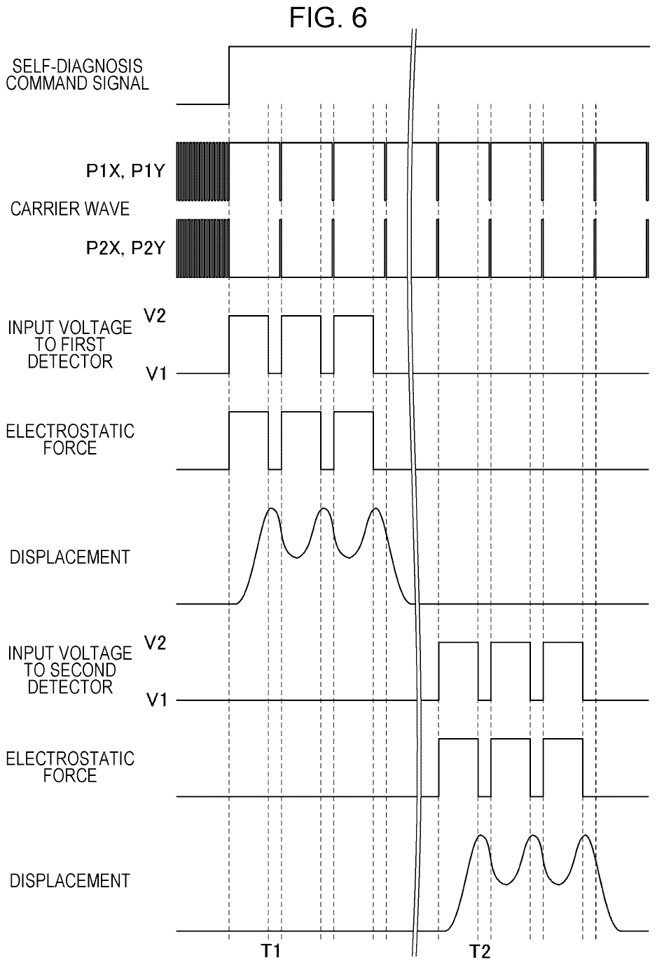

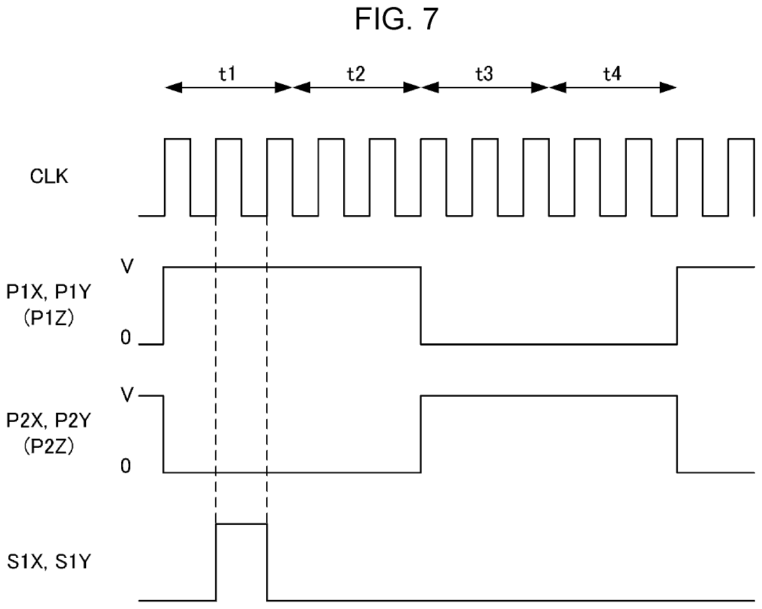

The operation of the acceleration sensor configured in this way will be described with reference to signal waveform diagrams shown in FIGS. 6 and 7. FIG. 6 shows a signal waveform at the time of switching from the normal acceleration detection to the self-diagnosis, and FIG. 7 is an enlarged view of a signal waveform at the time of acceleration detection.

First, as shown in FIG. 6, at the time of normal acceleration detection, the self-diagnosis command signal is set to the Low level, and acceleration detection is performed. The operation at this time will be described with reference to FIG. 7. Although not shown in FIG. 7, at the time of normal acceleration detection, the switches 220a and 320a are opened and the switches 220b and 320b are closed based on the signals S2X and S2Y, so that the midpoint voltage V1 (2.5 V in the present embodiment) is applied to the non-inverting input terminals of the operational amplifiers 210a and 310a, and the movable electrodes 101a to 101d are set to the midpoint voltage V1.

The signals P1X and P2X and the signals P1Y and P2Y output from the control signal generation circuit 600 are signals having an amplitude V (5 V in the present embodiment) in which the voltage levels are inverted with respect to each other, and are constant-amplitude rectangular wave signals in which the Hi level and the Low level change over four periods t1 to t4. The voltage V is not limited to 5 V. For example, the voltage V may be 3 V, and the midpoint voltage V1 may be 1.5 V. Of course, in this case, the voltage V2 also changes to a value between 3 V and 1.5 V.

First, in the first period t1, the potentials of the fixed electrodes 102a and 102c are set to V and the potentials of the fixed electrodes 102b and 102d are set to 0 based on the signals P1X and P2X and the signals P1Y and P2Y, and the switches 210c and 310c are closed by the signals S1X and S1Y from the control signal generation circuit 600. Therefore, the movable electrodes 101a to 101d are biased to a potential of V/2 due to the operation of the operational amplifiers 210a and 310a, and the charge accumulated between the electrodes of the capacitors 210b and 310b serving as the feedback capacitance is discharged.

At this time, when capacitance C1 between the movable electrodes 101a and 101c and the fixed electrodes 102a and 102c and capacitance C2 between the movable electrodes 101b and 101d and the fixed electrodes 102b and 102d are in a relationship of C1>C2, the movable electrodes 101a to 101d are in a state where more negative charges are present, based on this relationship and the relationship of the potentials applied to the fixed electrodes 102a to 102d.

Next, in the second period t2, the potentials of the fixed electrodes 102a and 102c are kept at V and the potentials of the fixed electrodes 102b and 102d are kept at 0 based on the signals P1X and P2X and the signals P1Y and P2Y, and the switches 210c and 310c are opened by the signals S1X and S1Y from the control signal generation circuit 600. Therefore, charges corresponding to the state of the movable electrodes 101a to 101d are accumulated in the capacitors 210b and 310b. At this time, when voltage values corresponding to the charges accumulated in the capacitors 210b and 310b are output from the C-V conversion circuits 210 and 310, the output GoutX and GoutY at this time are sampled through the LPF circuit 230a and the GAIN circuit 230b.

Subsequently, in the third period t3, based on the signals P1X and P2X and the signals P1Y and P2Y, potentials are switched such that the potentials of the fixed electrodes 102 a and 102 c become 0, and the potentials of the fixed electrodes 102b and 102d become V, and the switches 210c and 310c are kept open by the signals S1X and S1Y from the control signal generation circuit 600.

At this time, the state of the charges of the movable electrodes 101a to 101d is opposite to that in the second period t2 due to the inversion of the signals P1X and P2X and the signals P1Y and P2Y. That is, when the relationship C1>C2 described above is satisfied, the inversion of the potentials applied to the fixed electrodes 102a to 102d causes the movable electrodes 101a to 101d to be in a state where more positive charges are present.

However, at this time, since a closed circuit is formed between the movable electrodes 101a to 101d and the capacitors 210b and 310b, and the amount of charge in the first period t1 is retained, charges overflowing from the balance of the amount of charge of the movable electrodes 101a to 101d move to and are accumulated in the capacitors 210b and 310b. Then, from the relationship of Q=CV, a voltage value which is proportional to the transferred amount of charge and is inversely proportional to the capacitance C of the capacitors 210b and 310b is output from the C-V conversion circuits 210 and 310.

Further, in the fourth period t4, based on the signals P1X and P2X and the signals P1Y and P2Y, the potentials of the fixed electrodes 102a and 102c are kept at 0 and the potentials of the fixed electrodes 102 b and 102 d are kept at V, and when the output of the C-V conversion circuits 210 and 310 are sufficiently stabilized, the values at this time are output to GoutX and GoutY through the LPF circuits 230a and 330a, and the GAIN circuits 230b and 330b.

Finally, the output GoutX and GoutY sampled in the second period t2 and the output GoutX and GoutY sampled in the fourth period t4 are differentially calculated. Based on this, the acceleration corresponding to the displacement of the movable electrodes 101a to 101d are detected.

Next, the operation at the time of self-diagnosis will be described based on FIG. 6. At the time of self-diagnosis, the self-diagnosis command signal input to the control signal generation circuit 600 is set to the Hi level, and various signals for self-diagnosis are output from the control signal generation circuit 600. In the present embodiment, diagnosis is performed in the order of self-diagnosis in the first detector and self-diagnosis in the second detector.

First, at the time of self-diagnosis for the first detector, based on the signals P1X and P2X and the signals P1Y and P2Y, a potential difference is formed between the fixed electrodes 102a and 102c and the fixed electrodes 102b and 102d. In the first detector, based on the signal S2X, the switch 220a of the switch circuit 220 is closed and the switch 220b is opened. Therefore, a voltage V2 (4 V in the present embodiment) different from the midpoint voltage V1 between the fixed electrodes 102a and 102b is applied to the non-inverting input terminal of the operational amplifier 210a for self-diagnosis.

As a result, a potential difference (4 V) between the movable electrodes 101b and the fixed electrode 102b becomes larger than a potential difference (1 V) between the movable electrode 101a and the fixed electrode 102a, and the electrostatic force increases, so that the movable electrodes 101a and 101b are forcibly moved from the center point by the electrostatic force. Subsequently, at the time T1, the switch circuit 220 performs switching based on the signal S2X, and the midpoint voltage V1 of the fixed electrodes 102a and 102b is applied to the non-inverting input terminal of the operational amplifier 210a, similar to the normal acceleration detection.

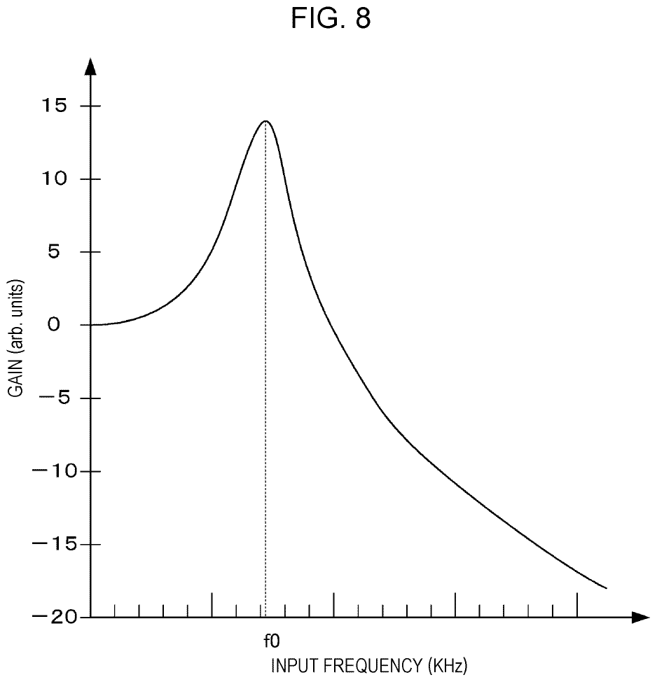

Through the above-described processing, the movable electrodes 101a and 101b can be displaced by the electrostatic force. In the present embodiment, a cycle of the drive signal S2X of the switch circuit 220 is set and the time for generation the electrostatic force is controlled so that the amount of displacement can be sufficiently detected. For example, the resonance frequency characteristics of the vibrations of the movable electrodes 101a and 101b with respect to the input frequency of the voltage applied to the movable electrodes 101a and 101b are expressed as shown in FIG. 8. In the present embodiment, the frequency of the input signal, that is, the frequency of the input voltage to the first detector shown in FIG. 6 is set to be the resonance frequency f0. As a result, the vibrations at the movable electrodes 101a and 101b are generated at the frequency at which the movable electrodes 101a and 101b resonate, that is, at the frequency where the displacement amplitude is the largest.

In the present embodiment, self-diagnosis related to the second detector is not performed at the time of self-diagnosis of the first detector. That is, based on the signal S2Y, the switch 320a of the switch circuit 320 is opened and the switch 320b is closed. Therefore, the midpoint voltage V1 between the fixed electrodes 102c and 102d is applied to the non-inverting input terminal of the operational amplifier 310a, and the self-diagnosis is not performed, similar to the normal acceleration detection.

Thereafter, the same operation as the above-described normal acceleration detection is performed for the first detector, and the output GoutX corresponding to the amount of displacement of the movable electrodes 101a and 101b is obtained. At this time, since the amount of displacement of the movable electrodes 101a and 101b due to the above-described electrostatic force is uniquely determined by the voltage applied to the non-inverting input terminal of the operational amplifier 210a, the output corresponding to the amount of displacement of the movable electrodes 101a and 101b is also uniquely determined. Therefore, self-diagnosis for the first detector is performed by comparing the obtained output with the self-diagnosis quantity (output) that is uniquely determined.

Next, the self-diagnosis for the second detector is performed after the elapse of a predetermined time from the completion of the self-diagnosis for the first detector. An interval between the self-diagnosis of the first detector and the self-diagnosis of the second detector is set to a length of time at which the deflection of the movable electrodes 101a and 101b, which are forcibly displaced at the time of the self-diagnosis of the first detector, stops. In the present embodiment, the movable electrodes 101a, 101b, 101c, and 101d are made of silicon. Therefore, the Q value is low. For example, the Q value of a quartz crystal vibrator frequently used in a gyro sensor or the like is on the order of 30,000 or the like, but the Q value of the movable electrodes 101a, 101b, 101c, and 101d configured as a silicon MEMS is about 20. Therefore, the vibration forcibly induced at the time of self-diagnosis of the first detector converges in a very short time.

At the time of self-diagnosis for the second detector, a potential difference is formed between the fixed electrodes 102a and 102c and the fixed electrodes 102b and 102d based on the signals P1X and P2X and the signals P1Y and P2Y. In the second detector, based on the signal S2Y, the switch 320a of the switch circuit 320 is closed and the switch 320b is opened. Therefore, a voltage V2 (4 V in the present embodiment) different from the midpoint voltage V1 between the fixed electrodes 102c and 102d is applied to the non-inverting input terminal of the operational amplifier 310a for self-diagnosis.

As a result, a potential difference (4 V) between the movable electrodes 101d and the fixed electrode 102d becomes larger than a potential difference (1 V) between the movable electrode 101c and the fixed electrode 102c, and the electrostatic force increases, so that the movable electrodes 101c and 101d are forcibly moved from the center point by the electrostatic force. Subsequently, at the time T2, the switch circuit 320 performs switching based on the signal S2Y, and the midpoint voltage V1 of the fixed electrodes 102c and 102d is applied to the non-inverting input terminal of the operational amplifier 310a, similar to the normal acceleration detection.

Through the above-described processing, the movable electrodes 101c and 101d can be displaced by the electrostatic force. In the present embodiment, a cycle of the drive signal S2Y of the switch circuit 320 is set and the time for generation the electrostatic force is controlled so that the amount of displacement can be sufficiently detected. In the present embodiment, also in the second detector, the frequency of the input signal, that is, the frequency of the input voltage to the second detector shown in FIG. 6 is set to be the resonance frequency f0. As a result, the vibrations at the movable electrodes 101c and 101d are generated at the frequency at which the movable electrodes 101c and 101d resonate, that is, at the frequency where the displacement amplitude is the largest.

The self-diagnosis related to the first detector is not performed at the time of self-diagnosis of the second detector. That is, based on the signal S2X, the switch 220a of the switch circuit 220 is opened and the switch 220b is closed. Therefore, the midpoint voltage V1 between the fixed electrodes 102a and 102b is applied to the non-inverting input terminal of the operational amplifier 210a, and the self-diagnosis is not performed, similar to the normal acceleration detection.

Thereafter, the same operation as the above-described normal acceleration detection is performed for the second detector, and the output GoutY corresponding to the amount of displacement of the movable electrodes 101c and 101d is obtained. At this time, since the amount of displacement of the movable electrodes 101c and 101d due to the above-described electrostatic force is uniquely determined by the voltage applied to the non-inverting input terminal of the operational amplifier 310a, the output corresponding to the amount of displacement of the movable electrodes 101c and 101d is also uniquely determined. Therefore, self-diagnosis for the second detector is performed by comparing the obtained output with the self-diagnosis quantity (output) that is uniquely determined.

### 2-2. Z-Direction Acceleration Sensor Element:

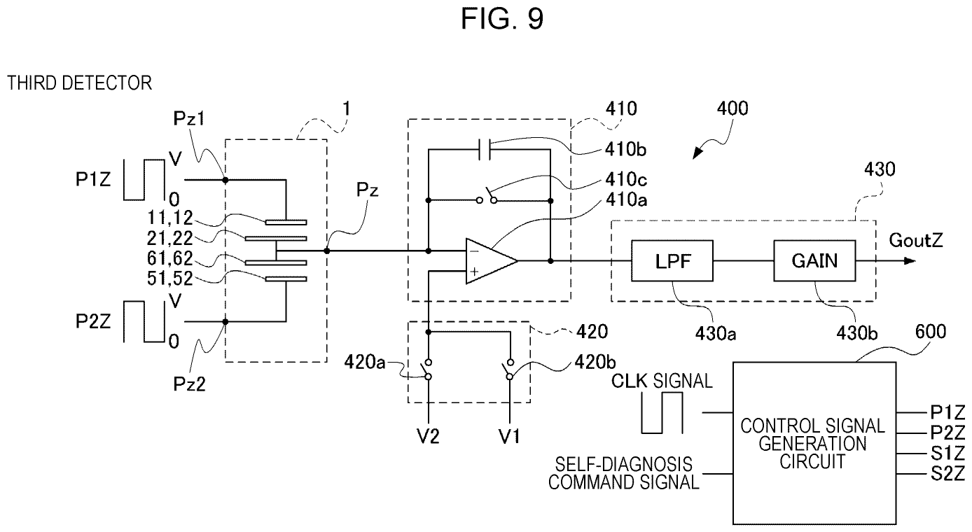

The Z-direction acceleration sensor element 1 is used by being coupled to the control IC (not shown). The control IC includes a circuit for detecting acceleration based on a signal output from the Z-direction acceleration sensor element 1. FIG. 9 is a diagram for explaining the circuit. In FIG. 9, the Z-direction acceleration sensor element 1 is shown together with elements and wirings constituting the circuit.

However, in FIG. 9, details of the structure of the Z-direction acceleration sensor element 1 are omitted, and the first movable comb electrodes 21 and 22, the second movable comb electrodes 61 and 62, the first fixed comb electrodes 11 and 12, and the second fixed comb electrodes 51 and 52 included in the Z-direction acceleration sensor element 1 are schematically shown.

The first movable comb electrodes 21 and 22 and the first fixed comb electrodes 11 and 12 constitute a parallel-plate capacitor oriented in a direction perpendicular to the second direction DR2. The second movable comb electrodes 61 and 62 and the second fixed comb electrodes 51 and 52 constitute a parallel-plate capacitor oriented in a direction perpendicular to the second direction DR2. As shown in FIG. 4, the first movable comb electrodes 21 and 22 and the second movable comb electrodes 61 and 62 are electrodes that are displaced in the third direction DR3 and the fifth direction DR5 in accordance with acceleration in the Z-direction, which is the third direction DR3. The positions of the first fixed comb electrodes 11 and 12 and the second fixed comb electrodes 51 and 52 are not displaced. When the first movable comb electrodes 21 and 22 and the second movable comb electrodes 61 and 62 are displaced in the third direction DR3 and the fifth direction DR5 in accordance with the acceleration in the Z-direction, which is the third direction DR3, the electrostatic capacitance formed by the first movable comb electrodes 21 and 22 and the first fixed comb electrodes 11 and 12 and the electrostatic capacitance formed by the second movable comb electrodes 61 and 62 and the second fixed comb electrodes 51 and 52 change.

As shown in FIG. 1, the Z-direction acceleration sensor element 1 includes a plurality of pads, and FIG. 9 shows coupling relationships between pads Pz, Pz1, and Pz2 and circuit components, and coupling relationships between the first movable comb electrodes 21 and 22, the second movable comb electrodes 61 and 62, the first fixed comb electrodes 11 and 12, and the second fixed comb electrodes 51 and 52 and the pads.

Here, a configuration for performing acceleration detection in the Z-direction, which is the third direction DR3, is referred to as a third detector. The third detector includes a detection circuit 400 that detects acceleration based on a change in differential capacitance due to the first movable comb electrodes 21 and 22 and the first fixed comb electrodes 11 and 12, and a change in differential capacitance due to the second movable comb electrodes 61 and 62 and the second fixed comb electrodes 51 and 52.

The detection circuit 400 includes a C-V conversion circuit 410, a switch circuit 420, a signal processing circuit 430, and a control signal generation circuit 600. In the present embodiment, the control signal generation circuit 600 is shared with the first detector and the second detector, but may be a different circuit.

The C-V conversion circuit 410 is a circuit that converts a change in the differential capacitance of the electrostatic capacitance formed by the first movable comb electrodes 21 and 22, the second movable comb electrodes 61 and 62, the first fixed comb electrodes 11 and 12, and the second fixed comb electrodes 51 and 52 into a voltage. Specifically, the C-V conversion circuit 410 includes an operational amplifier 410a, a capacitor 410b, and a switch 410c.

The inverting input terminal of the operational amplifier 410a is coupled to the first movable comb electrodes 21 and 22 and the second movable comb electrodes 61 and 62, and the capacitor 410b and the switch 410c are coupled in parallel between the inverting input terminal and the output terminal. The switch 410c is driven by a signal S1Z from the control signal generation circuit 600. To the non-inverting input terminal of the operational amplifier 410a, either a voltage V1 (that is, a midpoint voltage, 2.5 V in the present embodiment) that is half the potential difference between the first fixed comb electrodes 11 and 12 and the second fixed comb electrodes 51 and 52 or a voltage V2 (4 V in the present embodiment) that is different from the midpoint voltage is input via the switch circuit 420.

The switch circuit 420 inputs voltages from respective voltage sources (not shown) to the non-inverting input terminal of the operational amplifier 410a in the C-V conversion circuit 410. Specifically, the switch circuit 420 includes switches 420a and 420b. The switches 420a and 420b are driven based on a signal S2Z from the control signal generation circuit 600 and when one of them is closed, the other is opened.

The signal processing circuit 430 includes a low-pass filter (LPF) circuit 430a and a GAIN circuit 430b. The LPF circuit 430a removes high-frequency components from the output of the C-V conversion circuit 410, and extracts only components in a predetermined frequency band. The GAIN circuit 430b amplifies the output after passing through the LPF circuit 430a, and outputs the amplified output as an acceleration signal GoutZ.

The control signal generation circuit 600 outputs signals (carrier waves) P1Z and P2Z indicating the voltage application timing to each of the first fixed comb electrodes 11 and 12 and the second fixed comb electrodes 51 and 52, a signal S2Z indicating the switching timing of the switch of the switch circuit 420, and a signal S1Z indicating the switching timing of the switch 410c.

The various signals generated by the control signal generation circuit 600 vary between the time of normal acceleration detection (when not in self-diagnosis) and the time of self-diagnosis. That is, the control signal generation circuit 600 outputs various signals based on a clock signal CLK, and outputs a signal for acceleration detection when a self-diagnosis command signal is at a low level, and outputs a signal for self-diagnosis when the self-diagnosis command signal is at a Hi level.

The self-diagnosis is processing in which a signal for self-diagnosis is input to the Z-direction acceleration sensor element 1, and it is determined to be normal when the obtained output is within a predetermined value range, and it is determined to be abnormal when the obtained output is out of the range. That is, when the obtained output is out of the predetermined value range, it can be considered that an abnormality such as breakage of the comb teeth included in the Z-direction acceleration sensor element 1 occurs.

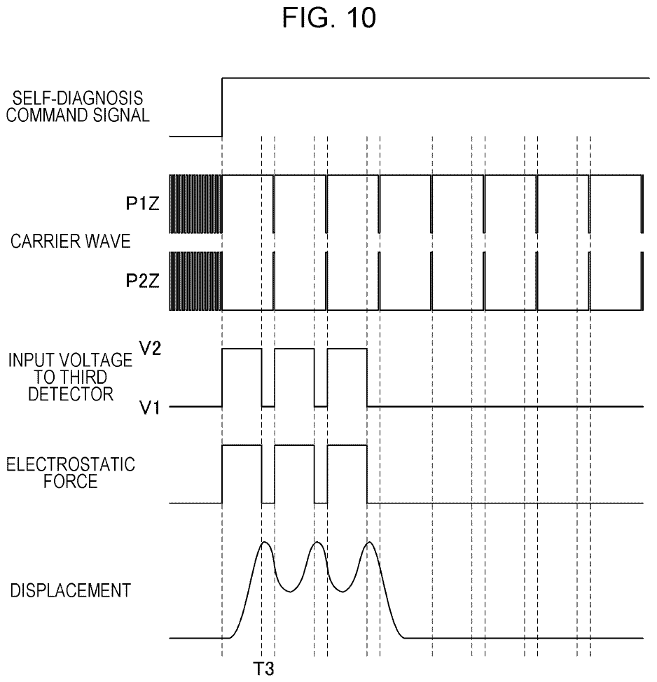

The operation of the acceleration sensor configured in this way will be described with reference to signal waveform diagrams shown in FIGS. 10 and 7. FIG. 10 shows a signal waveform at the time of switching from the normal acceleration detection to the self-diagnosis, and since the signal waveform shown in FIG. 10 has the same waveform as that of the signal shown in FIG. 6, FIG. 7, which is an enlarged view of the signal waveform at the time of acceleration detection, is used again for explanation.

First, as shown in FIG. 10, at the time of normal acceleration detection, the self-diagnosis command signal is set to the Low level, and acceleration detection is performed. The operation at this time will be described with reference to FIG. 7. Although not shown in FIG. 7, at the time of normal acceleration detection, the switch 420a is opened and the switch 420b is closed based on the signal S2Z, a midpoint voltage V1 (2.5 V in the present embodiment) is applied to the non-inverting input terminal of the operational amplifier 410a, and the first movable comb electrodes 21 and 22 and the second movable comb electrodes 61 and 62 are set to the midpoint voltage V1.

Signals P1Z and P2Z output from the control signal generation circuit 600 at the time of normal operation which is not self-diagnosis are signals for detecting capacitance changes. Specifically, the signals P1Z and P2Z are signals having an amplitude V (5 V in the present embodiment) in which voltage levels are inverted to each other, and are rectangular wave signals having constant amplitude in which the Hi level and the Low level are changed in four periods t1 to t4. The voltage V is not limited to 5 V. For example, the voltage V may be 3 V, and the midpoint voltage may be 1.5 V. Of course, in this case, the voltage V2 also changes to a value between 3 V and 1.5 V.

First, in the first period t1, the potential of the first fixed comb electrodes 11 and 12 is set to V and the potential of the second fixed comb electrodes 51 and 52 is set to 0 based on the signals P1Z and P2Z, and the switch 410c is closed by the signal S1Z from the control signal generation circuit 600. Therefore, the first movable comb electrodes 21 and 22 and the second movable comb electrodes 61 and 62 are biased to the potential of V/2 due to the operation of the operational amplifier 410a, and the charge accumulated between the electrodes of the capacitor 410b serving as the feedback capacitance is discharged.

At this time, when the capacitance C1 between the first movable comb electrodes 21 and 22 and the first fixed comb electrodes 11 and 12 and the capacitance C2 between the second movable comb electrodes 61 and 62 and the second fixed comb electrodes 51 and 52 have a relationship of C1>C2, the first movable comb electrodes 21 and 22 and the second movable comb electrodes 61 and 62 have a large amount of negative charges based on this relationship and a relationship of potentials applied to the first fixed comb electrodes 11 and 12 and the second fixed comb electrodes 51 and 52.

Next, in the second period t2, the potential of the first fixed comb electrodes 11 and 12 is kept at V and the potential of the second fixed comb electrodes 51 and 52 is kept at 0 based on the signals P1Z and P2Z, and the switch 410c is opened by the signal S1Z from the control signal generation circuit 600. Therefore, charges corresponding to the states of the first movable comb electrodes 21 and 22 and the second movable comb electrodes 61 and 62 are accumulated in the capacitor 410b. At this time, when a voltage value corresponding to the charge accumulated in the capacitor 410b is output from the C-V conversion circuit 410, the output GoutZ at this time is sampled through the LPF circuit 430a and the GAIN circuit 430b.

Subsequently, in the third period t3, the potential is switched so that the potential of the first fixed comb electrodes 11 and 12 becomes 0 and the potential of the second fixed comb electrodes 51 and 52 becomes V based on the signals P1Z and P2Z, and the switch 410c is kept open by the signal S1Z from the control signal generation circuit 600.

At this time, the states of the charges of the first movable comb electrodes 21 and 22 and the second movable comb electrodes 61 and 62 become opposite to those in the second period t2 due to the inversion of the signals P1Z and P2Z. That is, when the relationship C1>C2 is satisfied as described above, the first movable comb electrodes 21 and 22 and the second movable comb electrodes 61 and 62 have a large amount of positive charges due to the inversion of the potential applied to the first fixed comb electrodes 11 and 12 and the second fixed comb electrodes 51 and 52.

However, at this time, since a closed circuit is formed between the first movable comb electrodes 21 and 22 and the second movable comb electrodes 61 and 62 and the capacitor 410b, and the amount of charge in the first period t1 is retained, charges overflowing from the balance of the amount of charge of the first movable comb electrodes 21 and 22 and the second movable comb electrode 61 and 62 move to and are accumulated in the capacitors 410b. Then, from the relationship of Q=CV, a voltage value which is proportional to the transferred amount of charge and is inversely proportional to the capacitance C of the capacitor 410b is output from the C-V conversion circuit 410.

In the fourth period t4, the potential of the first fixed comb electrodes 11 and 12 is kept at 0 and the potential of the second fixed comb electrodes 51 and 52 is kept at V based on the signals P1Z and P2Z, and when the output of the C-V conversion circuit 410 is sufficiently stabilized, the value at this time is output to the GoutZ via the LPF circuit 430a and the GAIN circuit 430b.

Finally, the output GoutZ sampled in the second period t2 and the output GoutZ sampled in the fourth period t4 are differentially calculated. Based on this, acceleration detection corresponding to the displacement of the first movable comb electrode 21 and 22 and the second movable comb electrode 61 and 62 is performed.

Next, the operation at the time of self-diagnosis will be described based on FIG. 10. At the time of self-diagnosis, the self-diagnosis command signal input to the control signal generation circuit 600 is set to the Hi level, and various signals for self-diagnosis are output from the control signal generation circuit 600.

The signals P1Z and P2Z output from the control signal generation circuit 600 at the time of self-diagnosis are signals for displacing the first movable comb electrodes and the second movable comb electrodes in order to perform self-diagnosis. Specifically, a potential difference is formed between the first fixed comb electrodes 11 and 12 and the second fixed comb electrodes 51 and 52 based on the signals P1Z and P2Z output from the control signal generation circuit 600. Then, based on the signal S2Z, the switch 420a of the switch circuit 420 is closed and the switch 420b is opened. Therefore, a voltage V2 (4 V in the present embodiment) different from the midpoint voltage V1 between the first fixed comb electrodes 11 and 12 and the second fixed comb electrodes 51 and 52 is applied to the non-inverting input terminal of the operational amplifier 410a for self-diagnosis.

Through the above-described processing, before the time T3, the potential difference (4 V) between the second movable comb electrodes 61 and 62 and the second fixed comb electrodes 51 and 52 becomes larger than the potential difference (1 V) between the first movable comb electrodes 21 and 22 and the first fixed comb electrodes 11 and 12. Subsequently, at the time T3, the switch circuit 420 performs switching based on the signal S2Z, and the midpoint voltage V1 of the fixed electrodes 102a and 102b is applied to the non-inverting input terminal of the operational amplifier 410a, similar to the normal acceleration detection.

When the above-described processing is performed, the movable electrodes 101a and 101c or the movable electrodes 101b and 101d can be largely displaced in the above-described XY-direction acceleration sensor element 101. On the other hand, in the Z-direction acceleration sensor element 1, it is difficult to largely displace the first movable comb electrodes 21 and 22 and the second movable comb electrodes 61 and 62. Specifically, the force acting on the electrode due to the voltage applied to the electrostatic capacitance mainly acts in a direction perpendicular to the plates of the parallel-plate capacitor. In the XY-direction acceleration sensor element 101, the direction in which the movable electrodes 101a and 101c and the movable electrodes 101b and 101d are displaced is a direction perpendicular to the plates constituting the parallel-plate capacitor. Therefore, in the XY-direction acceleration sensor element 101, by increasing the voltage applied between the electrodes, it is possible to increase the force in the displaceable direction of the movable electrodes 101a, 101b, 101c, and 101d.

On the other hand, in the Z-direction acceleration sensor element 1, as shown in FIG. 4, the direction in which the first movable comb electrode 21 and 22 and the second movable comb electrode 61 and 62 are displaced is a direction parallel to the plates constituting the parallel-plate capacitor. Therefore, in the Z-direction acceleration sensor element 1, even when the voltage applied between the electrodes is increased, it is difficult to increase the force in the displaceable direction of the first movable comb electrode 21 and 22 and the second movable comb electrode 61 and 62.

Therefore, the Z-direction acceleration sensor element 1 according to the present embodiment is configured such that the force in the displaceable direction of the first movable comb electrode 21 and 22 and the second movable comb electrode 61 and 62 can be changed. That is, the Z-direction acceleration sensor element 1 has self-diagnosis electrodes E1 and E2 interposing the first movable comb electrodes 21 and 22, the first fixed comb electrodes 11 and 12, the second movable comb electrodes 61 and 62, and the second fixed comb electrodes 51 and 52.

Specifically, as shown in FIG. 3, the self-diagnosis electrode E1 is formed on the lid Cp, and the self-diagnosis electrode E2 is formed on the support substrate 2. The self-diagnosis electrode E1 is formed on an outer surface of the lid Cp, that is, on a plane on the positive side in the third direction DR3, and the self-diagnosis electrode E2 is formed on an outer surface of the support substrate 2, that is, on a plane on the negative side in the third direction DR3.

In the present embodiment, the self-diagnosis electrode E1 is formed on substantially the entire outer surface of the lid Cp, and the self-diagnosis electrode E2 is formed on substantially the entire outer surface of the support substrate 2. Therefore, the self-diagnosis electrodes E1 and E2 are interposed between the beam fixer 40, the first electrode fixer 3, the second electrode fixers 4 and 5, the support beam 42, the movable body MB, the first movable comb electrodes 21 and 22, the first fixed comb electrodes 11 and 12, the second movable comb electrodes 61 and 62, and the second fixed comb electrodes 51 and 52, which exist inside the space formed by the lid Cp and the support substrate 2.

Each of the self-diagnosis electrodes E1 and E2 is electrically coupled to the pads Pz1 and Pz2. Therefore, the signals P1Z and P2Z are applied to the self-diagnosis electrodes E1 and E2, respectively. According to the above-described configuration, the potential difference between the first movable comb electrodes 21 and 22 and the self-diagnosis electrode E1 in the lid Cp can be set to, for example, 1 V, and the potential difference between the second movable comb electrodes 61 and 62 and the self-diagnosis electrode E2 in the support substrate 2 can be set to, for example, 4 V. Since the main direction of the electric field generated by the potential difference is a direction along the third direction DR3, the first movable comb electrodes 21 and 22 and the second movable comb electrodes 61 and 62 can be forcibly displaced largely by the electrostatic force.

In the present embodiment, further, the cycle of the drive signal S2Z of the switch circuit 420 is set such that the amount of displacement of the first movable comb electrodes 21 and 22 and the second movable comb electrodes 61 and 62 becomes sufficiently large. Specifically, the resonance frequency characteristics of the vibrations of the first movable comb electrode 21 and 22 and the second movable comb electrode 61 and 62 with respect to the input frequency of the voltage applied to the first fixed comb electrode 11 and 12 and the second fixed comb electrode 51 and 52 are expressed as shown in FIG. 8. Therefore, in the present embodiment, the frequencies of the input signals (V1, V2) for displacing the first movable comb electrodes 21 and 22 and the second movable comb electrodes 61 and 62, that is, the frequencies in the input voltage to the third detector shown in FIG. 10 are set to be the resonance frequencies f0. As a result, the vibrations in the first movable comb electrodes 21 and 22 and the second movable comb electrodes 61 and 62 occur at a frequency at which the first movable comb electrodes 21 and 22 and the second movable comb electrodes 61 and 62 resonate, that is, at a frequency at which the displacement width becomes the largest.

Thereafter, the same operation as the above-described normal acceleration detection is performed for the third detector, and the output GoutZ corresponding to the amount of displacement of the first movable comb electrodes 21 and 22 and the second movable comb electrodes 61 and 62 is obtained. At this time, since the amount of displacement of the first movable comb electrodes 21 and 22 and the second movable comb electrodes 61 and 62 due to the above-described electrostatic force is uniquely determined by the voltage applied to the non-inverting input terminal of the operational amplifier 410a, the output corresponding to the amount of displacement of the first movable comb electrodes 21 and 22 and the second movable comb electrodes 61 and 62 is also uniquely determined. Therefore, self-diagnosis for the third detector is performed by comparing the obtained output with the self-diagnosis quantity (output) that is uniquely determined.

Specifically, in a state where some of the comb teeth constituting the first movable comb electrodes 21 and 22, the second movable comb electrodes 61 and 62, the first fixed comb electrodes 11 and 12, and the second fixed comb electrodes 51 and 52 are broken, the amount of displacement described above is reduced compared to a state where the comb teeth are not broken. However, when the amount of displacement is not large, the change in the amount of displacement due to breakage is small, and it is difficult to detect the change in the amount of displacement.

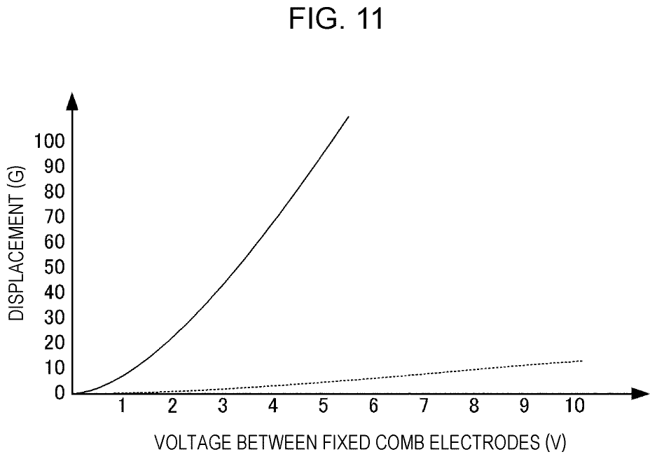

However, in the present embodiment, since the frequency of the input signals (V1, V2) is the resonance frequency of the first movable comb electrodes 21 and 22 and the second movable comb electrodes 61 and 62, a large displacement amount is obtained, and it is facilitated to detect changes in the amount of displacement due to slight breakage of the comb teeth. FIG. 11 is a diagram showing displacement with respect to the voltage between the first fixed comb electrodes 11 and 12 and the second fixed comb electrodes 51 and 52. In FIG. 11, the solid line shows an example when the frequency of the voltage is a resonance frequency, and the broken line shows an example when the frequency of the voltage is not a resonance frequency (1 Hz in the shown example). The displacement is a value of gravitational acceleration detected by the displacement of the first movable comb electrodes 21 and 22 and the second movable comb electrodes 61 and 62.

As shown in FIG. 11, for example, when the voltage as the input signal is 3 V, only the displacement corresponding to the displacement of 2G occurs when the frequency of the input signal is 1 Hz. On the other hand, when the frequency of the input signal is the resonance frequency, the displacement exceeding the displacement at 40G occurs. Therefore, there is a high possibility that even a slight breakage of the comb teeth causes a difference in the amount of displacement and an abnormality can be accurately detected.

In the present embodiment, the first movable comb electrodes 21 and 22 and the second movable comb electrodes 61 and 62 are made of silicon. Therefore, the Q value is low. For example, the Q value of a quartz crystal vibrator frequently used in a gyro sensor or the like is on the order of 30,000 or the like, but the Q value of the first movable comb electrodes 21 and 22 and the second movable comb electrodes 61 and 62 configured as a silicon MEMS is about 20. Therefore, the vibration forcibly induced at the time of self-diagnosis of the third detector converges in a very short time.

### 3. Other Embodiments and the Like

The above-described embodiments are examples of implementing the disclosure. Therefore, the configuration of each portion can be replaced with any configuration having the same function. Additionally, any other components may be added to the present disclosure.

The beam fixer, the first electrode fixer, and the second electrode fixer are portions extending in a direction perpendicular to the support substrate, and may be portions that support other portions. That is, the support substrate is a substrate that supports another structure, and each portion of the physical quantity sensor element is directly or indirectly supported by the support substrate. The beam fixer, the first electrode fixer, and the second electrode fixer are portions directly supported by the support substrate.

A portion regarded as being fixed without moving relative to the support substrate is regarded as a fixer, and a portion moved relative to the support substrate or a portion fixed to the support substrate is regarded as a mover. The beam fixer only needs to be able to support the support beam, and the support beam and a portion coupled to the support beam may be a mover. The first electrode fixer and the second electrode fixer are portions that support the first fixed comb electrode and the second fixed comb electrode, respectively. Therefore, the first electrode fixer and the second electrode fixer are portions that support the fixer. The beam fixer, the first electrode fixer, and the second electrode fixer only need to be coupled to other portions and be able to support other portions, and the shapes, sizes, and positions on the support substrate may be various aspects.

The support beam is a portion having one end coupled to the beam fixer and extending in a direction parallel to the support substrate. That is, one end of the support beam is coupled to the beam fixer extending in a direction perpendicular to the support substrate, and the support beam extends in a direction perpendicular to the beam fixer, that is, in a direction parallel to the support substrate. The other end of the support beam may be coupled to the movable body so that the movable body can be displaced relative to the support substrate.

In addition, the movable body exists on both sides with the support beam interposed, in a plan view. That is, by the movable body existing on both sides with the support beam interposed, the movable body only needs to be able to swing in a rotational direction centered on the support beam. The movable body may be displaced according to a physical quantity in a direction perpendicular to the support substrate, and displacement on both sides of the support beam may be different from each other. That is, the displacement of the first movable comb electrode and the displacement of the second movable comb electrode according to the physical quantity in the direction perpendicular to the support substrate may be different from each other.

For a configuration in which displacement according to a physical quantity in a direction perpendicular to the support substrate differs between the first movable comb electrode and the second movable comb electrode, various configurations can be adopted. For example, a configuration in which at least one of mass, size, and structure differs between the first movable comb electrode and the second movable comb electrode can be adopted.

The first movable comb electrodes and the first fixed comb electrodes only need to face each other. The first fixed comb electrode only needs to be configured to be fixed relative to the support substrate, and the first movable comb electrode only needs to be configured to be displaceable relative to the support substrate. That is, the area of the capacitor formed by the first movable comb electrode and the first fixed comb electrode only need to displaced by the displacement of the first movable comb electrode.

The second movable comb electrode and the second fixed comb electrode only need to face each other. The second fixed comb electrode only needs to be configured to be fixed relative to the support substrate, and the second movable comb electrode only needs to be configured to be displaceable relative to the support substrate. That is, the area of the capacitor formed by the second movable comb electrode and the second fixed comb electrode may be displaced by the displacement of the second movable comb electrode.

Further, the first movable comb electrode and the second movable comb electrode are displaced due to the structure in which the mover is supported by the support beam. Therefore, the first movable comb electrode and the second movable comb electrode are displaced in opposite directions to each other by the displacement in the rotational direction centered on the support beam.

The self-diagnosis electrodes only need to be electrodes interposing the first movable comb electrode, the first fixed comb electrode, the second movable comb electrode, and the second fixed comb electrode. That is, the configuration only needs to allow a signal for displacing the first movable comb electrode and the second movable comb electrode to be periodically applied between the self-diagnosis electrodes. The signal applied to the self-diagnosis electrodes only needs to be capable of displacing the first movable comb electrode and the second movable comb electrode. Such electrodes can adopt various configurations. For example, a configuration and the like may be adopted in which the first movable comb electrode, the first fixed comb electrode, the second movable comb electrode, and the second fixed comb electrode are interposed between plate-like electrodes parallel to the support substrate.

What is claimed is:

1. A physical quantity sensor element comprising:
a beam fixer, a first electrode fixer, and a second electrode fixer, which extend in a direction perpendicular to a support substrate;
a support beam having one end coupled to the beam fixer and extending in a direction parallel to the support substrate;
a movable body coupled to another end of the support beam and disposed on both sides with the support beam interposed therebetween in a plan view;
a first movable comb electrode coupled to the movable body and disposed on one side with the support beam interposed therebetween in plan view;
a first fixed comb electrode coupled to the first electrode fixer and facing the first movable comb electrode;
a second movable comb electrode coupled to the movable body and disposed on another side with the support beam interposed therebetween in plan view;
a second fixed comb electrode coupled to the second electrode fixer and facing the second movable comb electrode; and
self-diagnosis electrodes interposing the first movable comb electrode, the first fixed comb electrode, the second movable comb electrode, and the second fixed comb electrode.

2. The physical quantity sensor element according to claim 1, further comprising:
the support substrate; and
a lid disposed at a position facing the support substrate, wherein
one of the self-diagnosis electrodes is provided on the support substrate,
another of the self-diagnosis electrodes is provided on the lid, and
in an accommodation space interposed between the support substrate and the lid,
the beam fixer, the first electrode fixer, the second electrode fixer, the support beam, the movable body, the first movable comb electrode, the first fixed comb electrode, the second movable comb electrode, and the second fixed comb electrode are accommodated.

3. A physical quantity sensor device comprising:
the physical quantity sensor element according to claim 1;
a control signal generation circuit configured to periodically apply, during normal operation that is not self-diagnosis, a signal for detecting a capacitance change between the first movable comb electrode and the first fixed comb electrode and between the second movable comb electrode and the second fixed comb electrode, respectively, and
configured to periodically apply, at a time of self-diagnosis, a signal for displacing the first movable comb electrode and the second movable comb electrode between the self-diagnosis electrodes in order to perform self-diagnosis instead of the signal for detecting the capacitance change;
a C-V conversion circuit configured to output a voltage corresponding to a change in capacitance between the first movable comb electrode and the first fixed comb electrode and a change in capacitance between the second movable comb electrode and the second fixed comb electrode; and
a signal processing circuit configured to perform signal processing on the output voltage of the C-V conversion circuit and output a signal corresponding to a change in a physical quantity.

4. The physical quantity sensor device according to claim 3, wherein
a frequency of a signal periodically applied between the self-diagnosis electrodes to displace the first movable comb electrode and the second movable comb electrode coincides with a resonance frequency of the first movable comb electrode and the second movable comb electrode.
